(19) United States
(12) Patent Application Publication
(10) Pub. No.: US 2024/0424548 A1
(43) Pub. Date: Dec. 26, 2024

(54) PRODUCTION SYSTEM AND METHOD FOR MANUFACTURING METAL CANS

(71) Applicant: BELVAC PRODUCTION MACHINERY, INC., Lynchburg, VA (US)

(72) Inventors: Ulf REINHARDT, Teutschenthal (DE); Wilko HARMS, Wittmund (DE)

(21) Appl. No.: 18/684,448

(22) PCT Filed: Aug. 19, 2022
(86) PCT No.: PCT/DE2022/100624

§ 371 Date: Feb. 16, 2024

(30) Foreign Application Priority Data
Aug. 20, 2021 (DE) 10 2021 121 718.0

(51) Int. Cl. B21D 51/26

(52) U.S. Cl. CPC B21D 51/26

(57) ABSTRACT

The invention relates to a production system for manufacturing metal cans, including a manufacturing system for manufacturing the cans using thermal energy and/or electrical energy, an energy generation device for generating electrical energy and thermal energy, the manufacturing system being thermally and electrically coupled to the energy generation device in order to provide thermal energy and electrical energy to the manufacturing system so that the efficiency of the manufacturing system is increased.

### CROSS-REFERENCE TO RELATED APPLICATIONS

This application is a U.S. national stage of International Application No. PCT/DE2022/100624, filed Aug. 19, 2022, which claims the benefit of and priority to German Patent Application No. 10 2021 121 718.0, filed Aug. 20, 2021, each of which is hereby incorporated by reference herein in its entirety.

### FIELD

The invention relates to a production system and a method for manufacturing metal cans.

### BACKGROUND

Production systems for the manufacture of metal cans are generally known. Typically, such production systems comprise a large number of manufacturing devices that are arranged sequentially in a line. For example, a can forming device for forming the can body, a printing device for coating the cans, a pin oven for drying the outer coating, an interior coater, a can interior dryer, also known as an IBO, as well as several cleaning devices and drying devices for drying cans containing cleaning fluid.

Furthermore, such production systems can have an exhaust gas purification unit for the thermal conversion of the solvents produced, also known as a Regenerative Thermal Oxidizer or RTO for short. The process temperature of the exhaust gas purification unit is approx. 900° C. If the exhaust gas purification unit comprises a catalytic converter, the process temperature is approx. 500° C. Furthermore, the process fluid entering the waste gas purification unit can be pre-concentrated so that the process in the waste gas purification unit can be self-sustaining, i.e. without additional external heating.

Such a production system requires the use of a large amount of thermal and electrical energy.

For example, the can coatings are dried at approx. 200° C. In addition, cleaning fluids with a temperature of approx. 60-80° C. are used in the cleaning device and oil with a temperature of 80° C. is used in the can forming device. A temperature of between 500-900° C. is reached in the exhaust gas purification unit.

A gas burner, which usually emits CO2, is usually used to set the high temperatures of the fluids used. Heating coils can be used to adjust the lower temperatures of the fluids used. Furthermore, a large number of drives within the production system require electrical energy. Thermal energy consumption is usually essentially the same as electrical energy consumption. The carbon footprint of such a production system is inadequate, especially considering the energy currently available, which is predominantly generated using coal and oil worldwide. It should also be borne in mind that the efficiency of such production systems is low, for example around 30%.

There is a demand from industry and politics to make the manufacturing of cans more energy-efficient. In particular, the aim is to reduce CO2 emissions and avoid them where possible. In addition, due to constantly rising energy costs, a further reduction in energy consumption is desirable in order to lower the costs of manufacturing metal cans.

### SUMMARY

According to one embodiment, a production system for manufacturing metal cans is disclosed. The system comprises a manufacturing system for manufacturing the cans using thermal energy and/or electrical energy. The system further comprises an energy generation device for generating electrical energy and thermal energy. The manufacturing system are thermally and electrically coupled to the energy generation device in order to provide thermal energy and electrical energy to the manufacturing system so that the efficiency of the manufacturing system is increased.

According to another embodiment, a method of manufacturing metal cans is disclosed. The method comprises generating thermal energy and electrical energy by means of an energy generation device. The method further comprises transferring the thermal energy and/or electrical energy to a manufacturing system for manufacturing the cans. The method further comprises manufacturing of the cans with the thermal energy and/or electrical energy provided.

### BRIEF DESCRIPTION OF THE DRAWINGS

Preferred exemplary embodiments are explained by way of example with reference to the enclosed figures. It shows:

FIG. 1: a schematic, two-dimensional view of an exemplary embodiment of a production system; and

FIG. 2: a schematic representation of a method.

In the figures, identical or essentially functionally identical or similar elements are designated with the same reference symbols.

### DETAILED DESCRIPTION

It is therefore a task of the invention to provide a production system and a method for manufacturing metal cans which reduce or eliminate one or more of the disadvantages mentioned. In particular, it is a task of the invention to provide a solution that enables CO2-reduced or CO2-free manufacturing of metal cans.

This problem is solved with a production system and a method according to the features of the independent patent claims. Further advantageous embodiments of these aspects are indicated in the respective dependent patent claims. The features listed individually in the patent claims and the description can be combined with one another in any technologically meaningful way, wherein further embodiments of the invention are shown.

According to a first aspect, the problem is solved by a production system for manufacturing metal cans, in particular two-piece cans, comprising a manufacturing system for manufacturing the cans with thermal energy and/or electrical energy, an energy generation device for generating electrical energy and thermal energy, wherein the manufacturing system is thermally and electrically coupled to the energy generation device in order to provide thermal energy and electrical energy to the manufacturing system, so that the efficiency of the manufacturing system is increased.

The invention is based on the realization that the efficiency of the manufacturing system can be increased by coupling it with an energy generation device. The efficiency is increased in particular by using the thermal energy of the energy generation device.

Furthermore, the invention is based on the knowledge that such energy generation devices generally provide energy carriers with thermal energies that have different energy levels, so that these different energy carriers, for example an exhaust gas and a cooling fluid, can be used specifically in the different manufacturing devices of the manufacturing system to optimize efficiency. The conversion of primary energy into thermal energy and electrical energy should take place close to the manufacturing system, as otherwise comparatively high losses occur during the transfer of thermal energy.

The manufacturing system is arranged and designed to produce cans. For this purpose, the manufacturing system preferably comprises at least one manufacturing device. It is particularly preferred that the manufacturing system has two or more manufacturing devices. The energy generation device is arranged and designed to generate electrical energy and thermal energy. For example, a primary energy source is converted into electrical energy and thermal energy. The energy generation device can be designed as a combined heat and power unit, for example.

The manufacturing system and the energy generation device are thermally and electrically coupled to each other. The thermal coupling of the manufacturing system with the energy generation device can, for example, be formed via an essentially fluid-tight line, such as a pipe. The electrical coupling can be formed by means of an electrical conductor, for example.

A preferred embodiment of the production system is characterized in that the energy generation device comprises a heat engine, which is arranged to provide the thermal energy, and a generator, which is arranged to provide the electrical energy.

The heat engine is a machine that converts heat into mechanical energy. The heat engine can be or comprise, for example, an internal combustion engine, a reciprocating steam engine, a [sterling motor] or a gas turbine. Furthermore, all other known heat engines are basically suitable for coupling with the generator. The energy generation device can also have a fuel cell. Furthermore, it is preferred that the generator is set up to provide all or part of the thermal energy.

A preferred embodiment of the production system is characterized by the fact that the energy generation device has an output of between 0.1 MW and 10 MW, in particular between 2 MW and 5 MW, for example 3 MW.

In particular, a power output is the total output power that is usually specified by manufacturers of power generation devices. Such a power generation device generates the electrical and thermal energy required by the manufacturing system to manufacture the cans. This enables a compact design of the production system and, in particular, essentially autonomous operation of the production system, especially in remote regions.

A further preferred embodiment of the production system is characterized in that the energy generation device and the manufacturing system are coupled to each other such that an energy carrier of the thermal energy is transferable from the energy generation device to the manufacturing system and the manufacturing system is arranged and configured to use the energy carrier as a process fluid in the manufacturing system. Furthermore, it may be preferred that the manufacturing system is arranged and designed to transfer the thermal energy of the energy carrier to a process fluid.

In the case that the energy carrier is used as a process fluid in the manufacturing system, for example, a cooling water of the heat engine can be used as a cleaning fluid in a cleaning device of the manufacturing system. In addition, for example, an exhaust gas from the heat engine can be used as a drying fluid in a pin oven, in which the outer coating of the cans is dried at approx. 180° C.

The transfer of the thermal energy of the energy carrier to a process fluid has the advantage that a higher energy density is made possible during the transport between the energy generation device and the manufacturing system and thus the insulation of the line between the energy generation device and the manufacturing system is simplified. Losses can also be reduced.

Furthermore, the amount of thermal energy transferred can be specifically controlled by means of such a transfer, so that only the amount of thermal energy actually required for the can manufacturing process is transferred. In addition, transferring the thermal energy of the energy carrier to the process fluid has the advantage that the process fluid is essentially provided free of water vapor. This enables better drying in the pin oven, for example.

In a further preferred embodiment of the production system, it is provided that the energy generation device has a heating unit for tempering the energy carrier in order to increase the thermal energy. This allows the temperature of the process fluid, for example 900° C. in an exhaust gas cleaning system, to be reached.

In the event that the thermal energy of the energy carrier is not sufficient for the specific manufacturing step of the cans in the manufacturing system, the thermal energy can be increased with a heating unit, for example a heating coil. This increases energy efficiency, as the heating unit can be designed to be smaller than is required in conventional production systems.

Furthermore, it is preferred that the production system comprises an exhaust gas purification unit which is arranged and designed to purify an exhaust gas from the energy generation device and the heating unit. The advantage of this arrangement is that only one exhaust gas cleaning system is required to clean the exhaust gases from the energy generation device and the heating unit.

A further preferred embodiment of the production system comprises a first heat exchanger arranged and adapted to transfer the thermal energy from the energy carrier to a transfer medium, a transfer unit for transferring the transfer medium to a second heat exchanger, wherein the second heat exchanger is arranged and adapted to transfer the transferred thermal energy to a process fluid of the manufacturing system.

The energy generation device has the advantage of increasing the decentralized and holistic energy supply as well as energy efficiency and for this purpose a spatial proximity to the manufacturing system is preferred. It is particularly preferred that the manufacturing system and the energy generation device are designed as a single unit.

The first heat exchanger is preferably included in the energy generation device. The second heat exchanger is preferably comprised by the manufacturing system, in particular by a manufacturing device described in more detail below.

The use of heat exchangers enables the thermal energy of the energy carrier to be transferred to a process fluid as described above. In addition, the arrangement of a first and a second heat exchanger enables a particularly efficient transfer of thermal energy from the energy generation device to the manufacturing system. The process fluid of the manufacturing system can generally be air, water or oil.

A further preferred embodiment of the production system is characterized in that the energy generation device is arranged and designed to provide the thermal energy as a first thermal energy with a first thermal energy level and as a second thermal energy with a second thermal energy level different from the first thermal energy level, in order to temper process fluids of the manufacturing system to different temperatures.

On the one hand, this temperature control refers to indirect temperature control by means of a heat exchanger or direct temperature control, in which case the energy sources of the first and second thermal energy are used directly as process fluids.

The provision of a first thermal energy and a second thermal energy with different energy levels has the particular advantage that these energies can be used specifically in the different manufacturing devices of the manufacturing system, wherein their different temperature requirements can be taken into account. This further increases the energy efficiency of the production system.

In a further preferred embodiment of the production system, it is provided that a first energy carrier of the first thermal energy is or comprises an exhaust gas of the heat engine, and/or a second energy carrier of the second thermal energy is or comprises a cooling fluid of the heat engine and/or the generator.

The exhaust gas from a heat engine usually has a high temperature, for example 500° C. The cooling fluid can have a temperature of 80° C., for example.

It is also preferable for the production system to have two heat exchanger systems. A first heat exchanger system may comprise a first heat exchanger for transferring the first thermal energy from the first energy carrier to a first transfer medium and a second heat exchanger for transferring the first thermal energy from the first transfer medium to a first process fluid having a high temperature.

A second heat exchanger system may comprise a third heat exchanger for transferring the second thermal energy from the second energy carrier to a second transfer medium and a second heat exchanger for transferring the second thermal energy from the second transfer medium to a second process fluid having a lower temperature than the temperature of the first process fluid.

A further preferred embodiment of the production system is characterized in that the manufacturing system comprises a first manufacturing device and a second manufacturing device, and the first manufacturing device and the second manufacturing device are thermally coupled to the energy generating device such that the first thermal energy is provided to the first manufacturing device and the second thermal energy is provided to the second manufacturing device.

It is particularly preferred that the first thermal energy level is higher than the second thermal energy level and the first manufacturing device is a pin oven, a can interior dryer and/or a thermal exhaust air cleaner, and/or the second manufacturing device is a can forming device, a cleaning device for cleaning the cans with a cleaning fluid and/or a drying device for drying cans containing cleaning fluid.

Thus, the first manufacturing device requires the use of a process fluid with a high temperature, which is provided by using the first thermal energy with the higher first thermal energy level. In addition, the second manufacturing device requires a process fluid with a lower temperature, which is provided by the use of the second thermal energy with a lower thermal energy level.

A further preferred embodiment of the production system comprises a control device which is set up to control the energy generation device in such a way that the thermal energy and the electrical energy are provided as a function of a demand of the manufacturing system for thermal energy and electrical energy.

The requirement of the manufacturing system for thermal energy and electrical energy can, for example, be dependent on the transport density of the cans by the first and/or second manufacturing device. Furthermore, a can characteristic of the cans can also lead to different thermal and electrical energy requirements.

It is furthermore preferred that the control device is set up to control a flow through the first heat exchanger and/or the second heat exchanger in order to set a temperature of the process fluid. The lower the flow rate through the first heat exchanger and/or the second heat exchanger is set, the lower the thermal energy transferred will usually be. This allows the production system to be more efficient.

The flow rate can be, for example, a flow volume and/or a flow rate per unit of time. In addition, the flow rate can be a flow velocity. In particular, the temperature can be a predefined temperature or a predefined temperature range.

It is also preferred that the transmission medium is a high-temperature oil.

In a further preferred embodiment of the production system, it is provided that the heat engine is designed to be operated with hydrogen and/or biogas. A heat engine designed in this way enables a production system that makes it possible to manufacture cans that are essentially completely CO2-free.

A further preferred embodiment of the production system comprises a photovoltaic unit for generating electrical energy from radiant energy, in particular sunlight, wherein the energy generation device provides the electrical energy as a function of the energy generated by the photovoltaic unit.

The environment of production systems is usually air-conditioned, as operators are usually working in the vicinity of the production system at least some of the time. This is usually the case during the day. As a result, the photovoltaic unit can be set up to operate an air conditioning system during the day. At night, the photovoltaic unit will essentially not generate any energy, although this is not necessary as air conditioning is not usually required at night.

It is preferred that the production system has a sensor for recording the electrical power. The sensor for detecting the electrical power can, for example, detect a current, a voltage and/or a phase position.

It is also preferred that the production system has a sensor for detecting the thermal output, for example a flow rate and/or a temperature. The flow rate can be measured, for example, via pressure difference, impellers or a thermal anemometer. The data recorded by one, two or more sensors can be used to determine energy savings. The energy saving can be shown to an operator by means of a display device.

According to a further aspect, the task mentioned at the beginning is solved by a method for the manufacturing of metal cans, comprising the steps: Generating thermal energy and electrical energy by means of an energy supply device, transmitting the thermal energy and/or electrical energy to a manufacturing system for manufacturing the cans, and manufacturing the cans with the thermal energy and/or electrical energy provided.

The method and its possible further developments have features or method steps that make them particularly suitable for use in a production system and its further developments.

For further advantages, embodiment variants and embodiment details of the further aspects and their possible embodiments, reference is also made to the previous description of the corresponding features and embodiments of the production system.

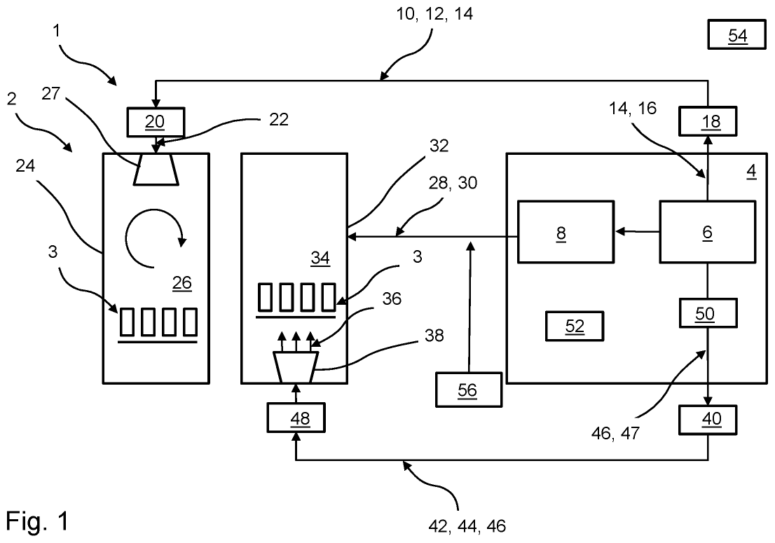

FIG. 1 shows a production system 1 for the manufacture of metal cans 3. The production system 1 comprises a manufacturing system 2 for manufacturing the cans using thermal energy and electrical energy. The manufacturing system 2 comprises a first manufacturing device 24, which is designed as a can interior dryer, a so-called IBO, which dries the cans 3 with a process fluid 22. In addition, the manufacturing system 2 comprises a second manufacturing device 32, which is designed as a cleaning device for cleaning the cans 3 with a cleaning fluid 36.

In addition, the production system 1 comprises an energy generation device 4, which has a heat engine 6 and a generator 8. The heat engine 6 is designed to generate kinetic energy to drive the generator 8. The generator 8 produces electrical energy. Furthermore, the energy generation device 4 generates thermal energy by means of the heat engine 6, in particular by means of an exhaust gas 16 and a heated cooling liquid 47. The manufacturing system 2 is thermally and electrically coupled to the power generation device 4 by means of a first transmission unit 10, a second transmission unit 42 and an electrical conductor 28. This provides the manufacturing system 2 with thermal energy and electrical energy, thereby increasing the efficiency of the manufacturing system 2. The energy generation device 4 can have an output of 3 MW, for example.

The energy generation device 4 is arranged and configured to provide the thermal energy as a first thermal energy 14 having a first thermal energy level and as a second thermal energy 46 having a second thermal energy level different from the first thermal energy level to temper the process fluids 22, 36 of the manufacturing system 2 to different temperatures. This is particularly advantageous since the can interior dryer 24 requires a temperature of, for example, 200° C. of the process fluid 22 and the cleaning device 32 requires a temperature of 60-80° C. of the process fluid 36.

Production system 1 also comprises two heat exchanger systems. The first heat exchanger system comprises a first heat exchanger 18 and a second heat exchanger 20. In the first heat exchanger 18, the first thermal energy 14 of the exhaust gas 16 is transferred to a first transfer medium 12. By means of the first transfer medium 12, the first thermal energy 14 is transported to the second heat exchanger 20 using the first transfer unit 10. In the second heat exchanger 20, the first thermal energy is transferred to the process fluid 22 of the first manufacturing device 24. Starting from the second heat exchanger, the process fluid 22 can flow into a drying chamber 26 of the first manufacturing device 24 by means of a first fluid device 27, for example a first fan, and dry the cans 3 within the drying chamber.

The second heat exchanger system comprises a third heat exchanger 40 and a fourth heat exchanger 48. The third heat exchanger 40 is arranged to transfer a second thermal energy 46 of the cooling liquid 47 of the heat engine 6 to a second transfer medium 44, with which the second thermal energy 46 is transferred to the fourth heat exchanger 48. The fourth heat exchanger 48 is arranged and configured to transfer the second thermal energy 46 to the process fluid 36 of the second manufacturing device 32. From there, the process fluid 36 flows by means of a second fluid device 38, for example a pump, into a cleaning chamber 34 of the cleaning device 32 in order to clean the cans 3 there.

Furthermore, a heating unit 50 is arranged, which is designed to control the temperature of the coolant 47. The temperature of the coolant 47 can thus be further increased to enable the process fluid 36 to be tempered accordingly. The heating unit 50 can also be arranged and designed to temper the exhaust gas 16.

The generator 8 is coupled to the electrical conductor 28 in order to transmit electrical energy 30 to the manufacturing system 2. Furthermore, the production system 1 may have a photovoltaic unit 56, which also provides electrical energy to the manufacturing system 1.

Furthermore, it is preferred that the production system comprises an exhaust gas purification unit 52 arranged and configured to purify an exhaust gas 16 of the energy generating device 4 and the heating unit 50.

In addition, the production system 1 comprises a control device 54 which is arranged to control the energy generation device 4 in such a way that the thermal energy 14, 46 and the electrical energy 30 are provided depending on a demand of the manufacturing system 2 for thermal energy and electrical energy. In addition, the control device 54 may be arranged to control a flow through the first heat exchanger 18, the second heat exchanger 20, the third heat exchanger 40 and/or the fourth heat exchanger 48 in order to adjust the temperature of the process fluids 22, 36.

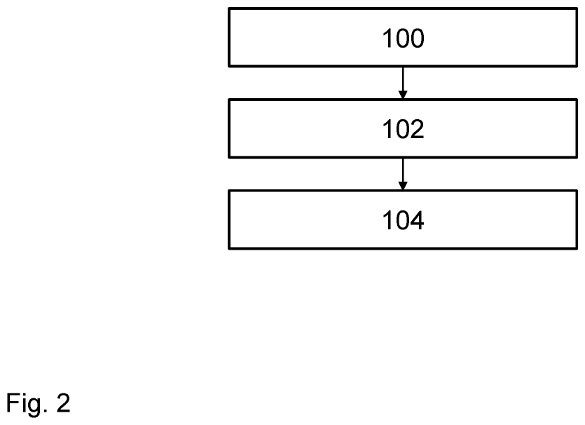

FIG. 2 shows a schematic representation of a method. In step 100, thermal energy 14, 46 and electrical energy 30 are generated by means of an energy supply device 4. In step 102, the thermal energy 14, 46 and/or the electrical energy 30 is transferred to a manufacturing system 2 for manufacturing the cans 3. In step 104, the cans 3 are manufactured using the thermal energy 14, 46 and/or electrical energy 30 provided.

The production system 1 described above is characterized by increased efficiency. The efficiency of this production system is approx. 80%, so that an increase of approx. 50percentage points is achieved. Such a production system 1 enables the manufacturing of cans 3 with a reduced CO₂ footprint or CO2-free. Considering that several hundred billion cans are manufactured worldwide every year, the production system 1 described above makes it possible to reduce CO₂ emissions by several million tons.

### REFERENCE SYMBOLS

1 Production system
2 Manufacturing system
3 Metal cans
4 Energy generation device
6 Heat engine
8 Generator
10 First transmission unit
12 First transmission medium
14 First thermal energy
16 First energy source, exhaust gas
18 First heat exchanger
20 Second heat exchanger
22 Process fluid
24 First manufacturing device
26 Drying chamber
27 First fluid device
28 Electrical conductor
30 Electrical energy
32 Second manufacturing device
34 Cleaning chamber
36 Process fluid
38 Second fluid device
40 Third heat exchanger
42 Second transmission unit
44 Second transmission medium
46 Second thermal energy
47 Second energy source, cooling fluid
48 Fourth heat exchanger
50 Heating unit
52 Exhaust gas cleaning unit
54 Control unit
56 Photovoltaic unit

1. A production system for manufacturing metal cans, the system comprising:
a manufacturing system for manufacturing the cans using thermal energy and/or electrical energy;
an energy generation device for generating electrical energy and thermal energy; and
the manufacturing system being thermally and electrically coupled to the energy generation device in order to provide thermal energy and electrical energy to the manufacturing system so that the efficiency of the manufacturing system is increased.

2. The production system according to claim 1, wherein the energy generation device comprises a heat engine arranged to provide the thermal energy and a generator arranged to provide the electrical energy.

3. The production system according to claim 1, wherein the energy generation device has a power of between 0.1 MW and 10 MW.

4. The production system according to claim 1, wherein the energy generation device and the manufacturing system are coupled to each other in such a way that an energy carrier of the thermal energy can be transferred from the energy generation device to the manufacturing system, and the manufacturing system is arranged and designed to
use the energy carrier as a process fluid in the manufacturing system, and/or
transfer the thermal energy of the energy carrier to a process fluid.

5. The production system according to claim 1, wherein the energy generation device has a heating unit for tempering the energy carrier to increase the thermal energy.

6. The production system according to claim 1, further comprising an exhaust gas purification unit arranged and configured to purify an exhaust gas of the energy generation device and the heating unit.

7. The production system according to claim 1, further comprising:
a first heat exchanger arranged and designed to transfer the thermal energy from the energy carrier to a transfer medium; and
a transfer unit for transferring the transfer medium to a second heat exchanger,
wherein the second heat exchanger is arranged and configured to transfer the transferred thermal energy to a process fluid of the manufacturing system.

8. The production system according to claim 1, wherein the energy generation device is arranged and configured to provide the thermal energy as a first thermal energy having a first thermal energy level and as a second thermal energy having a second thermal energy level different from the first thermal energy level to temper process fluids of the manufacturing system to different temperatures.

9. The production system according to claim 1, wherein
a first energy carrier of the first thermal energy is or comprises an exhaust gas of the heat engine, and/or
a second energy carrier of the second thermal energy is or comprises a cooling fluid of the heat engine and/or the generator.

10. The production system according to claim 1, wherein
the manufacturing system comprises a first manufacturing device and a second manufacturing device, and
the first manufacturing device and the second manufacturing device are thermally coupled to the energy generation device in such a way that the first thermal energy is provided to the first manufacturing device and the second thermal energy is provided to the second manufacturing device.

11. The production system according to claim 1, wherein
the first thermal energy level is higher than the second thermal energy level, and
the first manufacturing device is a pin oven, a can interior dryer, and/or a thermal exhaust air purifier, and/or
the second manufacturing device is a can forming device, a cleaning device for cleaning the cans with a cleaning fluid, and/or a drying device for drying cans which have been exposed to cleaning fluid.

12. The production system according to claim 1, further comprising a control device arranged to control the energy generation device such that the thermal energy and the electrical energy are provided in dependence on a demand of the manufacturing system for thermal energy and electrical energy.

13. The production system according to 1, wherein the control device is arranged to control a flow through the first heat exchanger and/or the second heat exchanger to adjust a temperature of the process fluid.

14. The production system according to claim 1, wherein the transfer medium is a high temperature oil.

15. The production system according to claim 1, wherein the heat engine is designed to be operated with hydrogen and/or biogas.

16. The production system according to claim 1, further comprising a photovoltaic unit for generating electrical energy from radiant energy, in particular sunlight, wherein the energy generation device provides the electrical energy as a function of the energy generated by the photovoltaic unit.

17. A method of manufacturing metal cans, the method comprising:
generating thermal energy and electrical energy by means of an energy generation device;
transferring the thermal energy and/or electrical energy to a manufacturing system for manufacturing the cans; and
manufacturing of the cans with the thermal energy and/or electrical energy provided.
